(19) United States
(12) Patent Application Publication
(10) Pub. No.: US 2012/0303386 A1
(43) Pub. Date: Nov. 29, 2012

(54) System for managing and sharing electronic medical records

(75) Inventors: Jeffrey R. Zavaleta, Fort Worth, TX (US); Samuel E. Kleinman, Fort Worth, TX (US); Daniel A. Dura, Garland, TX (US); Christopher R. Barker, Allen, TX (US)

(73) Assignee: Graphium, LLC, Fort Worth, TX (US)

(21) Appl. No.: 13/476,431

(22) Filed: May 21, 2012

Related U.S. Application Data
(60) Provisional application No. 61/489,046, filed on May 23, 2011.

(51) Int. Cl. G06Q 50/24

(52) U.S. Cl. 705/3

(57) ABSTRACT

Systems and methods for managing and sharing electronic medical records are provided. In one embodiment, a method includes receiving health care information from a health care provider or a health care institution. A determination is made as to whether or not a user is registered to receive health care information on a mobile device. The health care information is transmitted to the mobile device based at least in part on a determination that the user is registered. The health care information may also be transmitted to the mobile device based at least in part on an occurrence of a triggering event. The triggering event can occur while a patient is receiving health care or after a patient has received health care. The health care information may be received from an electronic medical record system or from a web portal.

### REFERENCE TO RELATED CASE

The present application is based on and claims the priority of provisional application Ser. No. 61/489,046 filed on May 23, 2011, the contents of which are hereby incorporated by reference in their entirety.

### BACKGROUND

When a person receives health care, there may be a number of noteworthy events that occur in the process. For example, when a person makes an office visit to a doctor, the person could have lab tests performed, receive a diagnosis, and be prescribed a medication. Information associated with these events can be communicated with the person in person, by a telephone call, by mail, or by a combination of different means.

In another example, a person receiving health care may be going to a hospital to have a procedure performed (e.g. surgery). There again may be a number of noteworthy events that occur in the process. The person receiving the health care and/or a person associated with that person (e.g. a spouse, parent, caregiver, etc.) may desire to be kept up-to-date with the progress or status of the procedure. For example, status updates could be given for events such as anesthesia start, surgery start, surgery end, anesthesia end, etc.

In light of the above, it can readily be seen that it may be desirable for a health care provider to provide information regarding the care of a patient in many different situations.

### SUMMARY

An aspect of the disclosure relates to managing and sharing electronic medical records. In one embodiment, a method includes receiving health care information from a health care provider or a health care institution. A determination is made as to whether or not a user is registered to receive health care information on a mobile device. The health care information is transmitted to the mobile device based at least in part on a determination that the user is registered. The health care information may also be transmitted to the mobile device based at least in part on an occurrence of a triggering event. The triggering event can occur while a patient is receiving health care or after a patient has received health care. The health care information may be received from an electronic medical record system or from a web portal. Furthermore, in addition to the health care information, other information (e.g. advertisements) can be transmitted to the mobile device.

These and various other features and advantages that characterize the claimed embodiments will become apparent upon reading the following detailed description and upon reviewing the associated drawings.

### BRIEF DESCRIPTION OF THE DRAWINGS

FIG. 1 is a block diagram of an operating environment for implementing an electronic medical records system.

FIG. 2 is a process flow diagram of a registration process.

FIG. 3 is a process flow diagram of a method of establishing a connection.

FIG. 4 is a process flow diagram of a communication process.

FIG. 5 is a table of triggering events and associated messages.

FIG. 6 is a block diagram of a home screen user interface.

FIG. 7 is a screenshot of a home user interface.

FIG. 8 is a screenshot of a providers user interface.

FIG. 9 is a screenshot of a provider details user interface.

FIG. 10 is a screenshot of a messages user interface.

FIG. 11 is a screenshot of an organizations user interface.

FIG. 12 is a screenshot of an organization details user interface.

FIG. 13 is a screenshot of an organization's providers user interface.

FIG. 14 is a screenshot of a medication user interface.

FIG. 15 is a screenshot of a location user interface.

FIG. 16 is a screenshot of a map list user interface.

FIG. 17 is a screenshot of a map display user interface.

FIG. 18 is a screenshot of a notes user interface.

FIG. 19 is a block diagram of a mobile device.

FIG. 20 is a process flow diagram of an event based advertising method.

### DETAILED DESCRIPTION

Embodiments of the present disclosure include a system for managing and sharing electronic medical records. In one embodiment, an electronic medical record and/or a web portal is connected to an individual's mobile device to provide medical and/or other types of information. For example, real-time updates about a patient's status and location can be sent to a mobile device. Additionally, other information (e.g. procedure and/or diagnosis information) can also be sent. In some embodiments, advertising may be sent such as, but not limited to, advertisements specific to an institution's businesses (e.g. cafeteria, gift shop, etc.), advertisements specific to a patient's medical providers (which may be optimized for sharing with other mobile device users and potential future clients), and advertisements specific to the current day and/or time.

Furthermore, a connection can also be used after a hospital encounter. For instance, the connection can be used to collect follow-up patient satisfaction surveys for the facility, institution, and/or providers. The connection can be used to notify established patients of new facility or institution related events, and the connection can be used to provide a resource to direct further potential patient encounters with facilities via provider location and facility look-up capabilities. These and other various features and advantages are described in greater detail below.

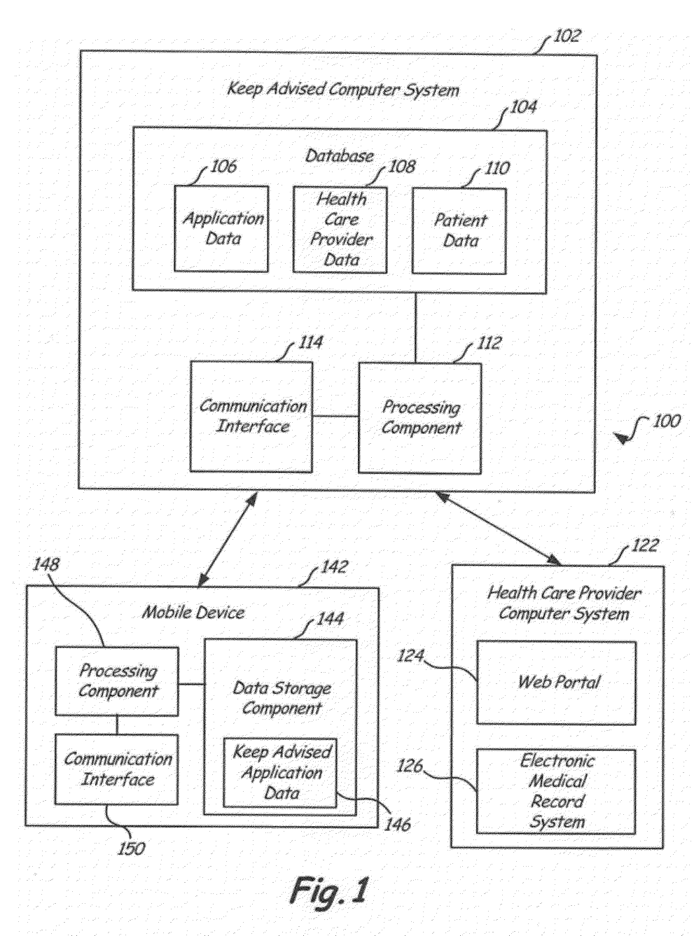

FIG. 1 is a block diagram of one illustrative environment 100 that can be utilized to implement certain embodiments of the present disclosure. Embodiments are not however limited to any particular environment, and embodiments can be implemented in environments that differ from the particular one shown in the figure.

Environment 100 includes a Keep Advised computer system 102, a health care provider computer system 122, and a mobile device 142. In an embodiment, the Keep Advised computer system 102 receives information such as, but not limited to, patient status information from the health care provider computer system 122, and then transmits that information to mobile device 142.

Keep Advised computer system 102 optionally includes a database 104 that includes application data 106, health care provider data 108, and patient data 110. Database 104 can be implemented utilizing one physical database or multiple physical databases. The data is processed utilizing a processing component 112, and the data and any other information is sent and received from the Keep Advised computer system 102 utilizing a communication interface 114.

Health care provider computer system 122 optionally includes a web portal 124 and an electronic medical record system 126. In an embodiment, either web portal 124 and/or electronic medical record system 126 can be used to collect patient information that is sent to the Keep Advised computer system 102. For instance, a message can be created and sent to a mobile device 142 utilizing web portal 124. Also for instance, patient status updates can be recorded to an electronic medical record system 126 which are then sent to mobile device 142 utilizing Keep Advised computer system 102.

Mobile device 142 optionally includes a data storage component 144 that can store data such as, but not limited to, Keep Advised application data 146. Mobile device 142 may also include a processing component 148 and a communications interface 142. Mobile device 142 is illustratively implemented utilizing a smart phone, a tablet computer, a notebook computer, or any other type of mobile device. Additionally, mobile device 142 can be communicatively coupled to Keep Advised computer system 102 utilizing any type of networking or communications technology (e.g. 2G/3G/4G cellular network, Wi-Fi, Ethernet, etc.).

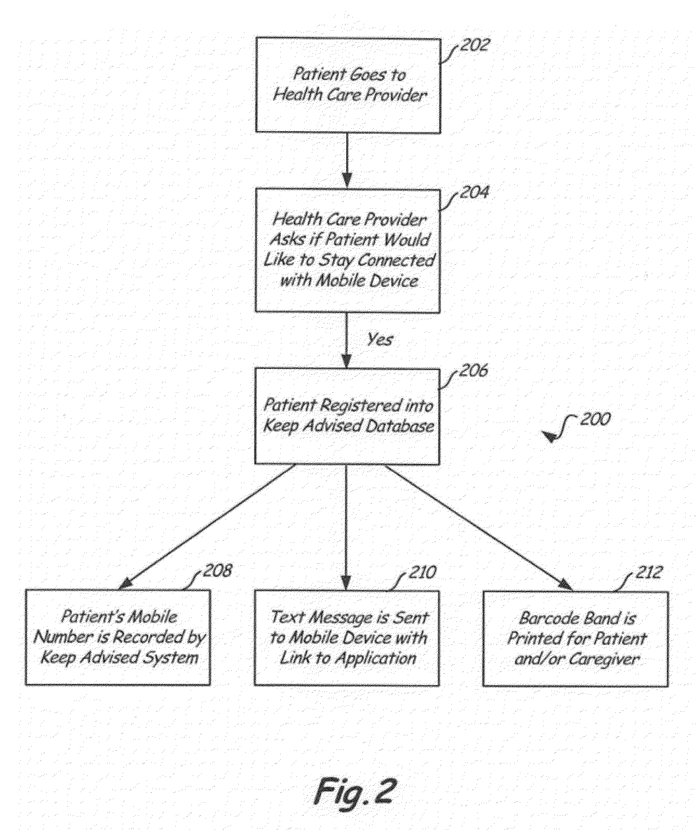

FIG. 2 is a process flow diagram of one illustrative embodiment of a registration process 200. At block 202, a patient goes to a health care provider. At block 204, the health care provider asks the patient if he or she would like to stay connected utilizing a mobile device. If the patient would like to stay connected utilizing a mobile device, then the health care provider enters the patient into the Keep Advised database at block 206. In one particular embodiment, a visit number is scanned into an electronic medical record (e.g. an anesthesia electronic medical record), and it is sent to the Keep Advised database.

At block 208, the patient's mobile number is optionally sent to and stored by the Keep Advised computer system, and at block 210, a text message is sent from the Keep Advised computer system to the patient's mobile device. The text message may include a link that enables the patient to download a Keep Advised mobile application to the mobile device. For instance, the link could direct the patient to an application store that enables him or her to download a copy of the Keep Advised mobile application for free.

At block 212, one or more barcode bands is optionally printed for the patient and/or for a person associated with the patient (e.g. a spouse, parent, caregiver, etc.). This barcode can be used for instance to store and/or retrieve status updates associated with the patient.

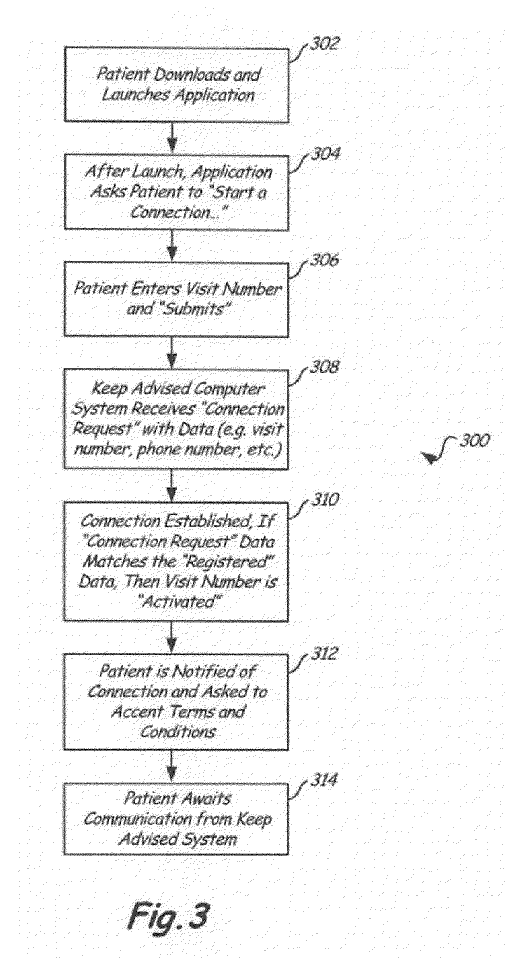

FIG. 3 is a process flow diagram of one illustrative embodiment of a process 300 for a patient establishing a connection to the Keep Advised system. At block 302, a patient downloads and launches the Keep Advised mobile application. At block 304, the application prompts the patient to “Start a Connection.” At block 306, the patient enters and submits a visit number (e.g. a visit number he or she received from the health care provider) into the application. At block 308, the Keep Advised computer system receives the connection request from the mobile device. The request illustratively includes the visit number and a phone number associated with the mobile device.

At block 310, a connection is established between the mobile device and the Keep Advised system if the connection request information (e.g. the information received at block 308) matches the registration information (e.g. the information entered into Keep Advised system at block 206 in FIG. 2). Additionally, the visit number may be activated within the Keep Advised system such that status updates and other information can be associated with the visit number. At block 312, the patient is notified of the connection and is asked to accept the terms and conditions. Then, at block 314, the patient awaits communication from the Keep Advised system (e.g. a communication from an electronic medical record).

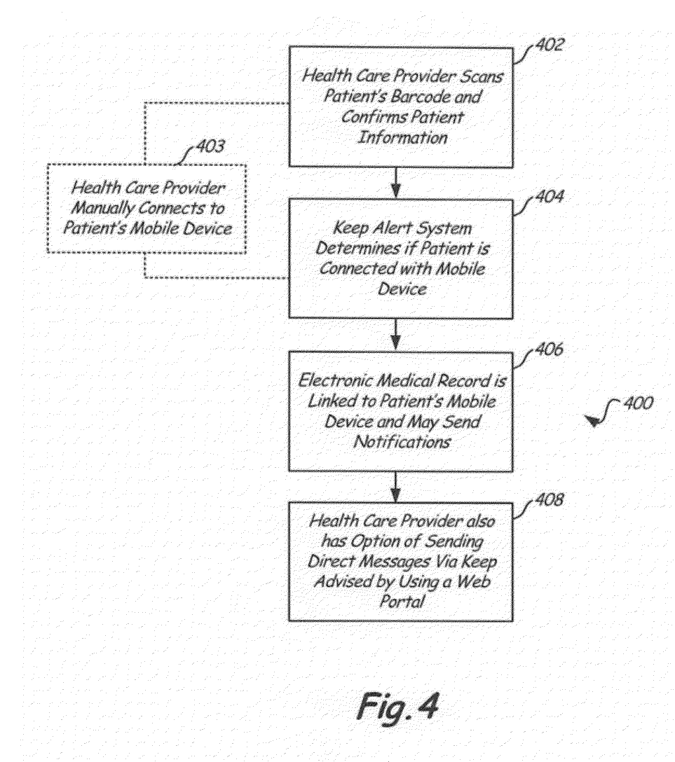

FIG. 4 is a process flow diagram of one illustrative embodiment of a process 400 for communicating during patient care. At block 402, a health care provider scans a patient's barcode and/or confirms patient information. In one embodiment, the patient's barcode is scanned into an electronic medical record system (e.g. an anesthesia electronic medical record). At block 404, the Keep Alert system determines if the patient is connected with a mobile device. If the patient is, then at block 406, the electronic medical record is linked to the patient's mobile device, and any status updates, etc. from the electronic medical record are sent to the patient's mobile device. Additionally, at block 408, the health care provider has an option to send direct messages to the patient's mobile device using a web portal.

As an alternative to scanning a patient's barcode to establish a connection to a patient's mobile device (e.g. block 402 in FIG. 4), other methods could be used instead. For example, as is illustrated by alternative block 403 in FIG. 4, a connection to a patient's mobile device can also be established manually. For instance, in one embodiment, a physician or healthcare provider can establish a connection to a patient's mobile device by selecting a patient's name from a drop down box in an electronic medical record system. Embodiments are of course however not limited to any particular method of connecting a mobile device to an electronic medical record system, and other methods can be used as well.

In one embodiment, a Keep Advised system may send an update or a message to a mobile device upon the occurrence of a triggering event. Some examples of triggering events include, but are not limited to, starting anesthesia, starting surgery, ending surgery, ending anesthesia, selection of a surgeon, selection of an anesthesiologist, making a diagnosis, performance of a procedure, and the time of day becoming a certain value. Some triggering events may occur after patient care has been performed such as the passing of a predetermined amount of time (e.g. one week since surgery) or a newsworthy event occurring after the patient care.

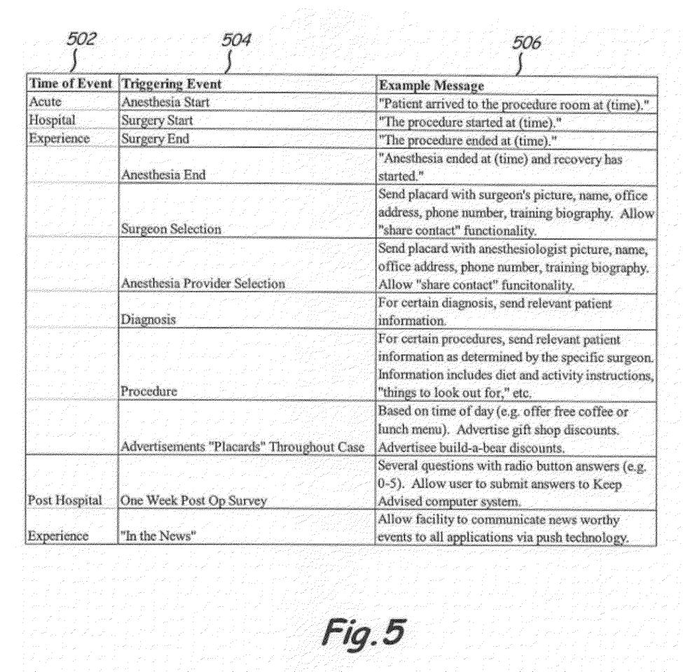

FIG. 5 shows examples of some triggering events and messages that are sent to a mobile device upon the occurrence of a triggering event. Time frames associated with the events are in column 502, descriptions of the triggering events are in column 504, and examples of messages that can be sent are in column 506. Embodiments of the present disclosure are not however limited to any particular triggering events and/or messages, and embodiments can include any triggering events and/or messages.

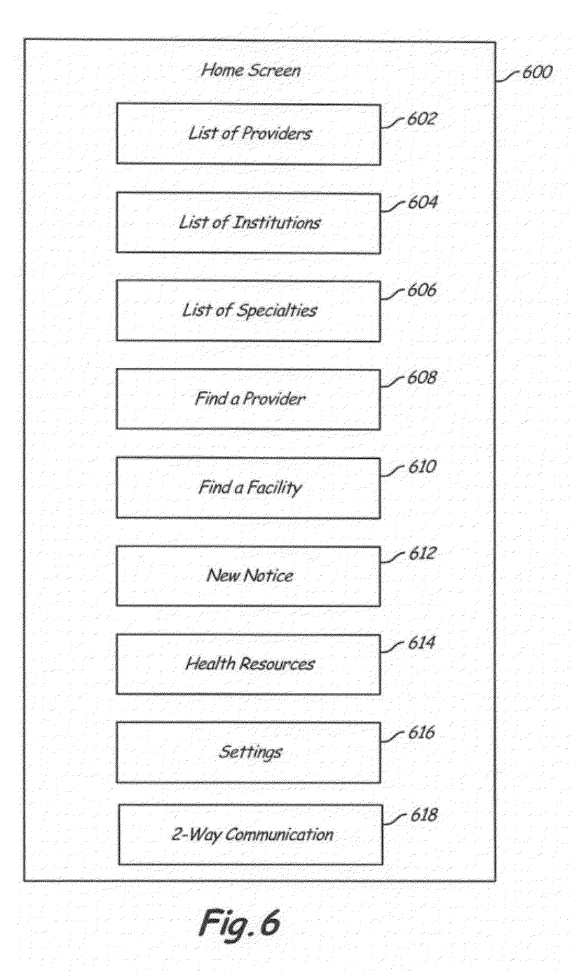

FIG. 6 shows a block diagram of a home screen user interface 600 for a mobile device application. Interface 600 illustratively has a number of menu buttons 602-618. Selection of list of providers button 602 generates a list of providers that the patient has had contact with. Selection of list of institutions button 604 generates a list of institutions that the patient has had contact with. Selection of list of specialties button 606 generates a list of specialties that the patient has had contact with. Selection of find a provider button 608 generates a list of providers that a patient may contact for care. For example, upon selection of button 608, a drop down menu of specific specialty providers could be generated. Then, if one of the providers is selected, contact information for the selected provider could be displayed (e.g. a digital map of the provider's location and/or a phone number for the provider).

Selection of find a facility button 610 generates a list of facilities (e.g. clinics, urgent care centers, hospitals, etc.) that a patient may contact for care. Similar to the find a provider button 608, selection of find a facility button 610 may generate a drop down menu of specific specialty facilities. Then, upon a selection of one of the facilities, contact information (e.g. a digital map of the location and/or a phone number) could be displayed.

Selection of new notice button 612 generates a screen with messages from the Keep Advised system to the patient. Some examples of possible notices could include upcoming events, satisfaction surveys, public relation items (e.g. “in the news” items), public health notifications, and vaccination schedules.

Selection of health resources button 614 generates a list of links to various online web resources (e.g. an Institution's website, WebMD, AMA, etc.), and selection of settings button 616 generates one or more user interfaces that enable the settings for the application to be configured. For example, a language preference (e.g. English, Spanish, etc.) could be set, push notifications can be set to on or off, and a connection can be deactivated. In an embodiment, if a connection is deactivated, all visit numbers associated with the phone number are deleted from the Keep Advised system.

Finally with respect to FIG. 6, selection of 2-way communication button 618 enables a user of the mobile device to communicate in real-time with a health care provider, organization, etc. For instance, a patient could use button 618 to communicate in real-time with a representative of a hospital that the patient is currently at (e.g. the patient and the representative could utilize button 618 to send text messages to each other).

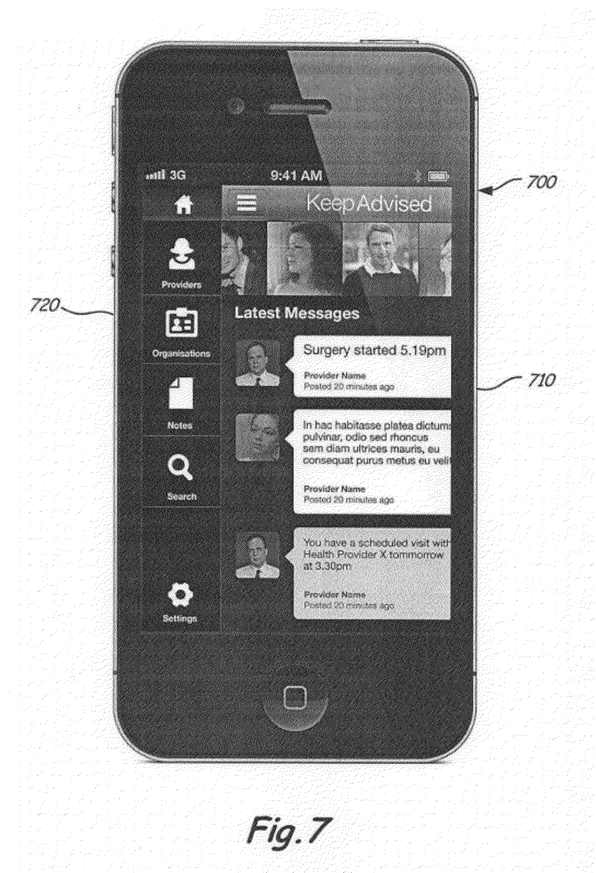

FIGS. 7-18 show examples of some possible user interfaces that can be used in a Keep Advised mobile device application. Embodiments of the present disclosure are not however limited to any particular user interfaces, and embodiments can include interfaces that are different from the specific examples shown in the figures.

FIG. 7 is a screenshot of a home user interface 700. Interface 700 illustratively includes a main portion 710 and a side portion 720. In an embodiment, main portion 710 includes a latest messages section that shows the most recent messages received by the Keep Advised application. In the specific example shown in the figure, each message includes a photograph of the provider, the provider's name, the content of the message, and an indication of a time when the message was received. Embodiments can however include any other information and/or combinations of information. Additionally, main portion 710 is illustratively updated in real-time such that new messages are added to the list as the information is generated.

Side portion 720 may include one or more menu buttons such as, but not limited to, a home button, a providers button, an organizations button, a notes button, a search button, and a settings button. The menu buttons illustratively perform functions that are the same or similar to the functions performed by menu buttons 602-618 in FIG. 6. In one embodiment, selection of the home button returns the application to the home screen. Selection of the providers button generates a list of providers. Selection of the organizations button generates a list of organizations. Selection of the notes button may be used to view, create, and/or manage notes. Selection of the search button can be used to perform any kind of search that is desirable (e.g. a search for providers, organizations, facility, notes, etc.), and selection of the settings button can be used to configure the application (e.g. select language, push notification setting, etc.).

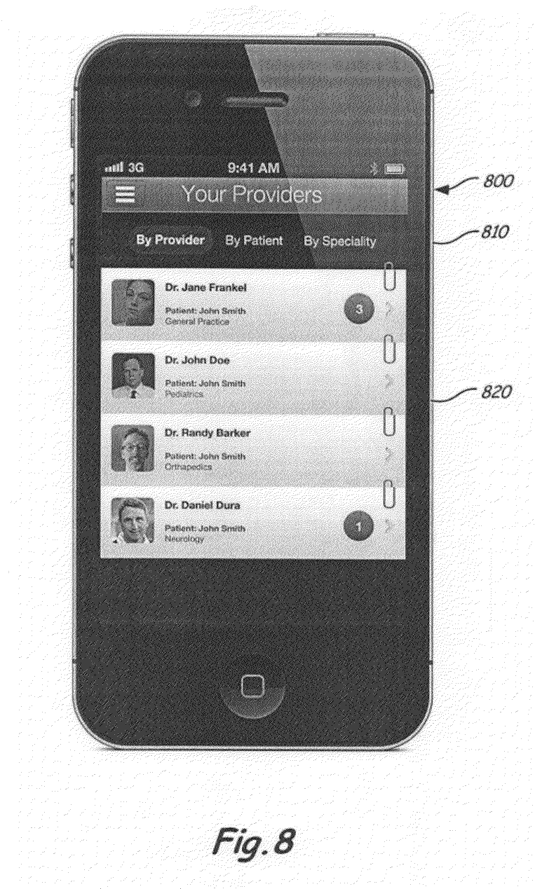

FIG. 8 is a screenshot of a providers user interface 800. Interface 800 can be generated for example by selection of the provider button shown in FIG. 7. Interface 800 illustratively includes a category section 810 that enables a user to display providers by different categories such as, but not limited to, by provider, by patient, and by specialty. The selected category is illustratively highlighted in section 810.

Interface 800 also includes a provider information section 820. Section 820 includes a list of providers. Each provider entry optionally includes a photograph of the provider, the name of the provider, the patient's name, a specialty of the provider, and a number of unread messages (e.g. 3 for Dr. Jane Frankel). Selection of one of the provider entries illustratively shows the messages from that provider.

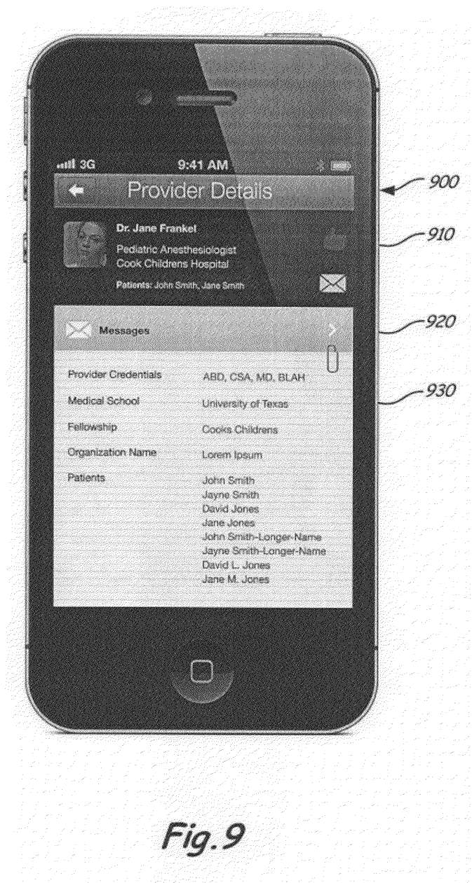

FIG. 9 is a screenshot of a provider details user interface 900. Interface 900 can be generated for example by selection of one of the providers in section 820 of FIG. 8. Interface 900 includes a provider summary section 910, a messages section 920, and a provider details section 930. Summary section 910 illustratively includes a photograph of the provider, the name of the provider, a specialty of the provider, an institution of the provider, and patients of the provider. Summary section 910 may also include a review icon (e.g. the thumbs-up icon) and/or a forwarding icon (e.g. the letter icon). These icons can be used to review a provider, and to forward the provider's information to another person. Additionally, message section 920 enables a user to view messages received from the provider, and provider details section 930 includes additional information about the provider (e.g. credentials, medical school, fellowship, organization name, patients, etc.).

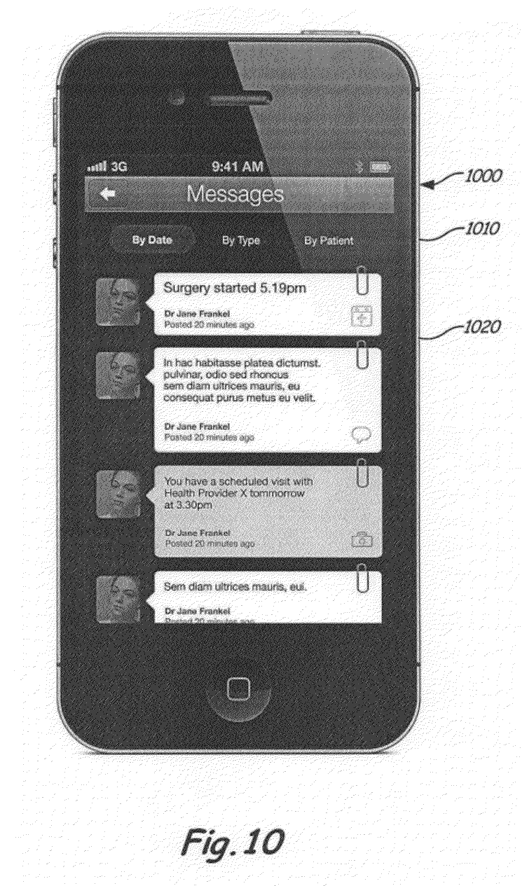

FIG. 10 is a screenshot of a messages user interface 1000. Interface 1000 can be generated for example by selection of messages section 920 in FIG. 9. Interface 1000 illustratively includes a category section 1010 that enables a user to display messages by different categories such as, but not limited to, by date, by type, and by patient. The selected category is illustratively highlighted in section 1010. The associated messages are then shown in section 1020. Each message entry illustratively includes a photograph of the provider, the content of the message, a time associated with the message, and any other information that may be desirable to include.

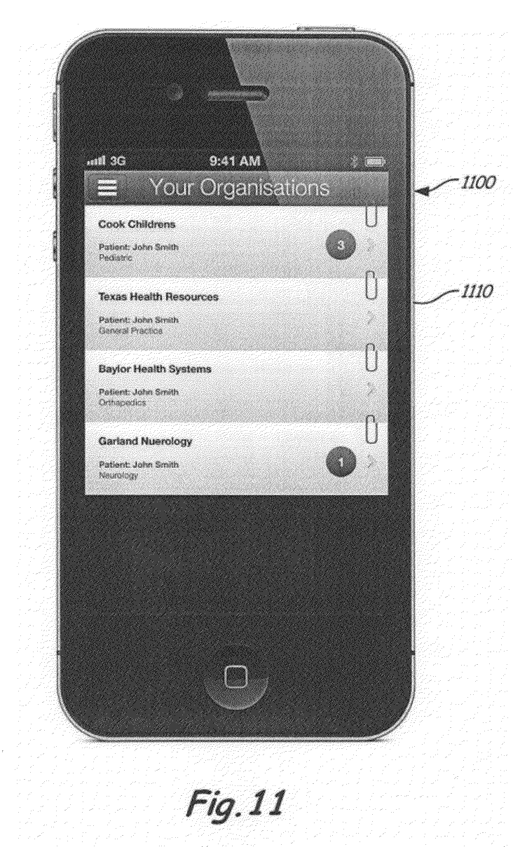

FIG. 11 is a screenshot of an organizations user interface 1100. Interface 1100 can be generated for example by selection of the organization button in FIG. 7. Interface 1100 illustratively includes a list of organization 1110. Each organization entry may include a name of the organization, a patient name, a specialty, and an indication of a number of unread messages. The entries may however include any other information and/or combination of information.

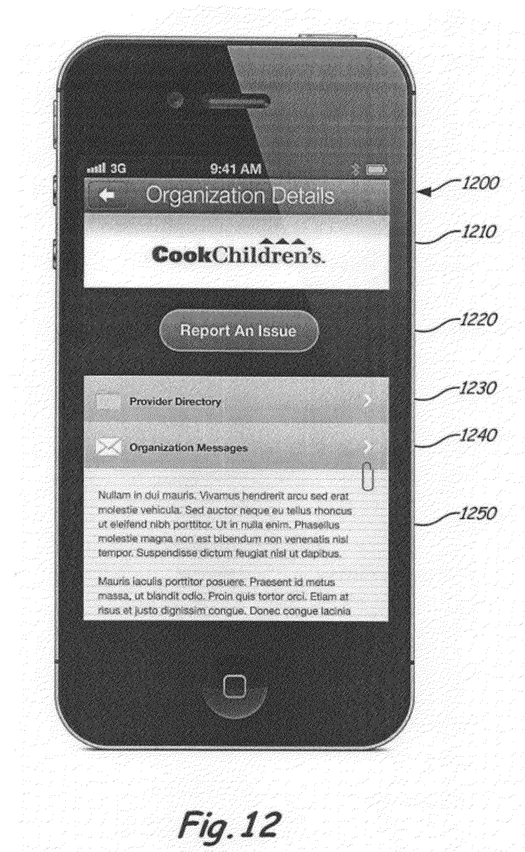

FIG. 12 is a screenshot of an organization details user interface 1200. Interface 1200 can be generated for example by selection of one of the organizations is section 1110 of FIG. 11. Interface 1200 illustratively include a name section 1210, a report an issue section 1220, a provider directory section 1230, an organization messages section 1240, and a content section 1250. Name section 1210 includes a name of the provider. Report an issue section 1220 includes a button that can be selected to report an issue to the provider. Provider directory section 1230 can be used to retrieve directory information for the provider. Organization messages section 1240 can be used to retrieve messages sent from the provider, and content section 1250 can be used to view additional information from or about the provider.

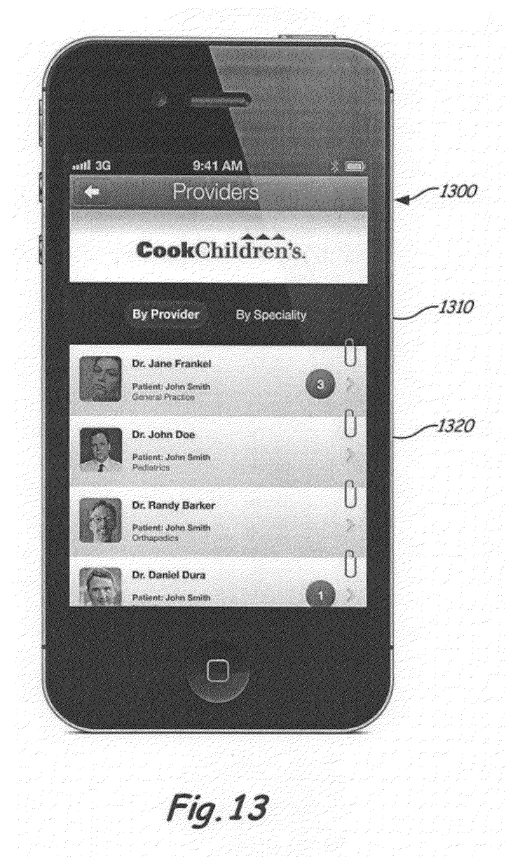

FIG. 13 is a screenshot of an organization's providers user interface 1300. Interface 1300 can be generated for example by selection of the provider directory button 1230 in FIG. 12. Interface 1300 illustratively includes a category section 1310 that enables a user to display providers by different categories (e.g. by provider, by specialty, etc.). The selected category is illustratively highlighted in section 1310. Section 1320 then displays a list of providers. Each entry for a provider optionally includes a photograph of the provider, a name of the provider, a name of the patient, a specialty of the provider, a number of unread messages, and an indication of a number of unread messages.

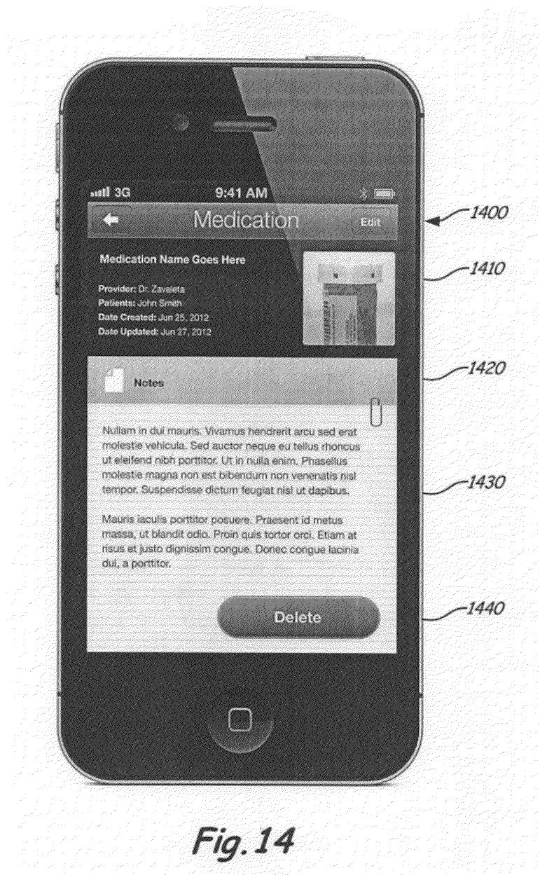

FIG. 14 is a screenshot of a medication user interface 1400. In an embodiment, a Keep Advised application may provide medication information to a user utilizing an interface such as, but not limited to, the interface shown in FIG. 14. Interface 1400 optionally includes a summary section 1410, a notes section 1420, a content section 1430, and a delete button 1430. Summary section 1410 may include a photograph of the medication, a name of the medication, the name of the provider that prescribed the medication, the name of the patient, the date the medication entry was created, and the date the medication entry was last updated. Notes section 1420 provides a link to notes about the medication. Content section 1430 provides additional details about the medication, and delete button 1430 enables a user to be able to delete the medication entry.

In one embodiment, medication information (e.g. information displayed in FIG. 14) may be generated in part by scanning a barcode of a prescription. For example, a patient may receive a prescription (e.g. a bottle of medicine) that has a barcode. The patient can then scan the barcode by taking a picture of it with a mobile device camera. The Keep Advised application can use the scanned barcode to identify and display information about the prescription (e.g. dosage, frequency, name, prescribing physician, date prescribed, expiration date, etc.). Additionally, the Keep Advised application can utilize the scanned barcode to retrieve and provide other information. For instance, the Keep Advised application can identify websites or other sources that may have additional information about the prescription (e.g. side effects, risks, known complications, etc.). The Keep Advised application may then present dynamic links to one or more of these other sources. These additional pieces of information (e.g. links) can be displayed in an interface such as interface 1400 in FIG. 14, or could alternatively be displayed in some other interface.

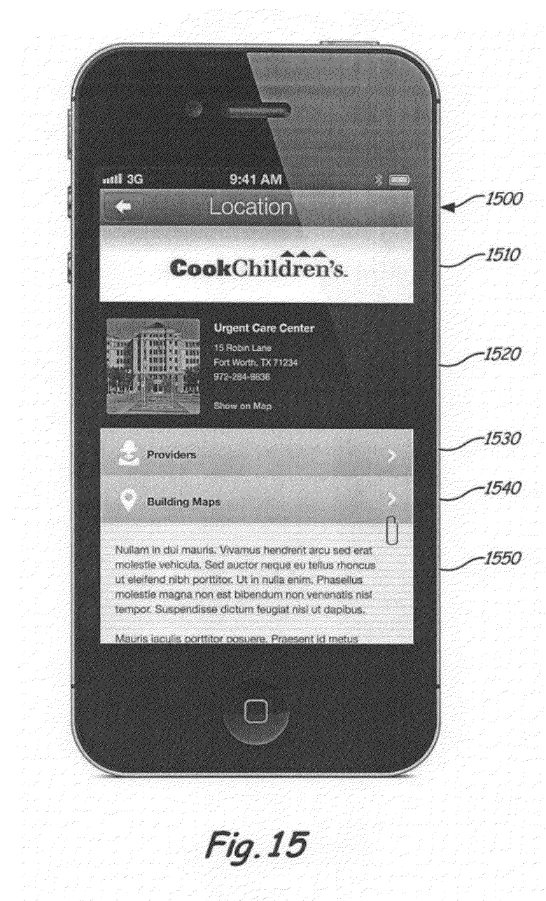

FIG. 15 is a screenshot of a location user interface 1500. In an embodiment, a user may utilize interface 1500 to view information about a location associated with a provider, an organization, etc. Interface 1500 illustratively includes a name section 1510, a contact information section 1510, a providers section 1530, a maps section 1540, and an additional content section 1550. Name section 1520 lists a provider or organization name associated with a location. Contact information section 1520 includes contact information such as, but not limited to, an address and phone number. Providers section 1530 can be used to generate a list of providers associated with the location. Maps section 1540 can be used to view maps associated with the location, and content section 1550 includes any additional information about the location.

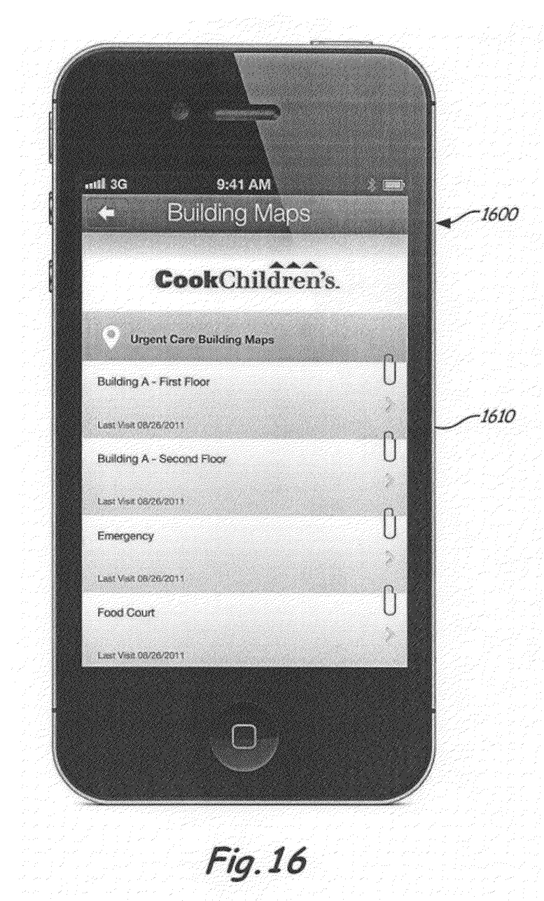

FIG. 16 is a screenshot of a maps list user interface 1600. Interface 1600 can be generated for example by selection of providers section 1530 in FIG. 15. Interface 1500 illustratively includes a list 1610 of maps that are available for viewing. Each entry in the list may include an indication of a building name, a floor level, a last visit date, a description of the map, and/or any other information.

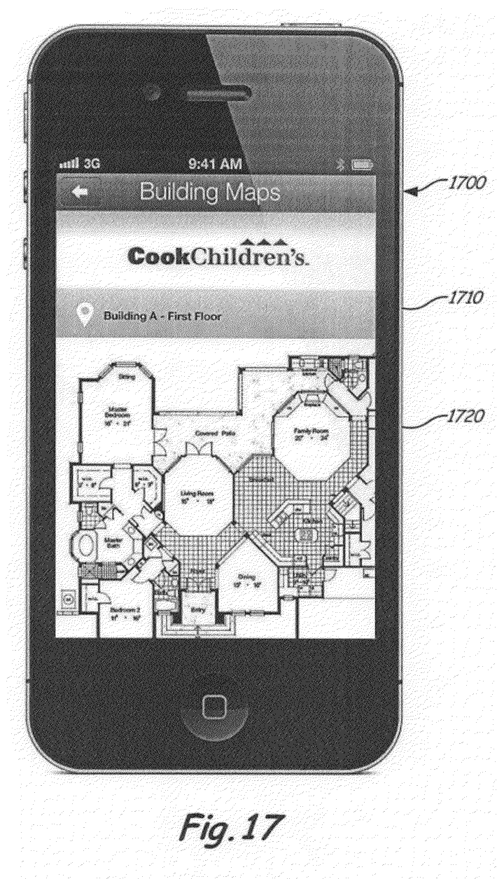

FIG. 17 is a screenshot of map display user interface 1700. Interface 1700 can be generated for example by selection of one of the entries in list 110 in FIG. 16. Interface 1700 illustratively includes a name/identifier of the map 1710 and a graphical display of the map 1720.

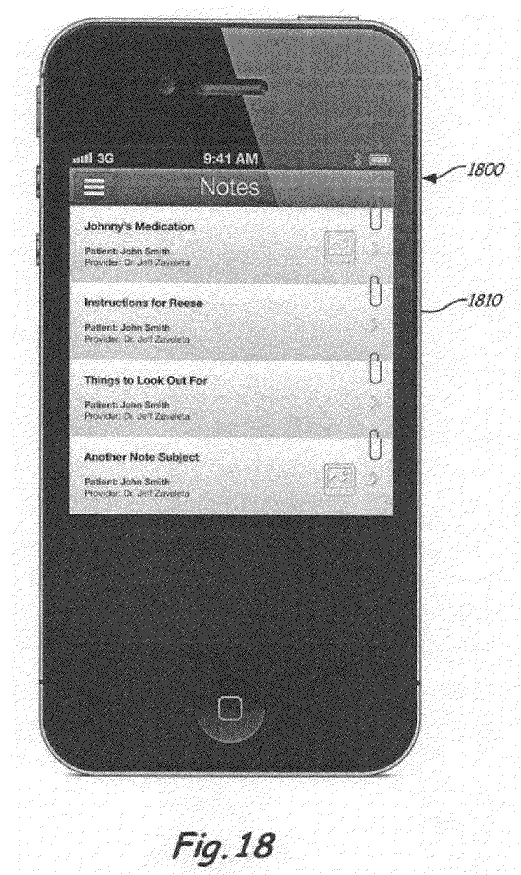

FIG. 18 is a screenshot of notes user interface 1800. Interface 1800 can be generated for example by selection of the notes button in FIG. 7. Interface 1800 includes a list of notes 1810. Each entry in the list optionally includes a title/name of the note, a patient name, a provider name, and any other information. Upon a selection of any of the entries in the list 1810, additional information about the selected note is displayed. Additionally, a new note can be added to the list of notes 1810 by entering a subject, patient, provider, and note details into a note creation interface. A photograph can also be added to a new note if desired.

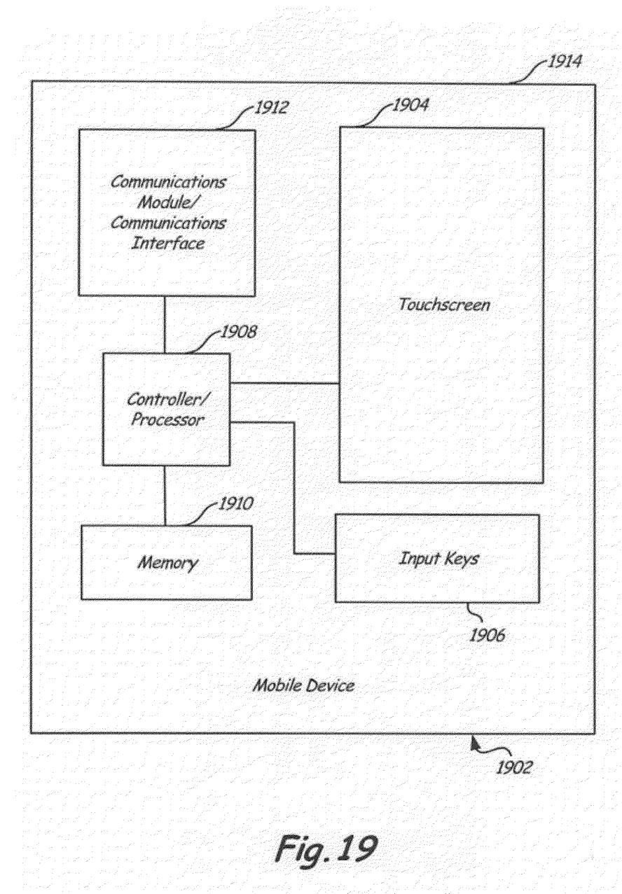

FIG. 19 shows a block diagram of one example of a mobile device. Certain embodiments of the present disclosure may be implemented utilizing a mobile device such as the one shown in FIG. 19. Embodiments are not however limited to any particular type or configuration of mobile device and may be implemented utilizing devices different than the one shown in the figure. Mobile device 1902 illustratively includes a touchscreen 1904, input keys 1906, a controller/processor 1908, memory 1910, a communications module/communications interface 1912, and a housing/case 1914.

Touchscreen 1904 illustratively includes any type of single touch or multitouch screen (e.g. capacitive touchscreen, vision based touchscreen, etc.). Touchscreen 1904 is able to detect a user's finger, stylus, etc. contacting touchscreen 1904 and generates input data (e.g. x and y coordinates) based on the detected contact. Input keys 1906 include buttons or other mechanical devices that a user is able to press or otherwise actuate to input data. For instance, input keys 1906 may include a home button, a back button, 0-9 number keys, a QWERTY keyboard, etc.

Memory 1910 includes volatile, non-volatile or a combination of volatile and non-volatile memory. Memory 1910 may be implemented using more than one type of memory. For example, memory 1910 may include any combination of flash memory, magnetic hard drives, RAM, etc. Memory 1910 stores the computer executable instructions that are used to implement the applications and/or user interfaces described above. Controller/processor 1908 can be implemented using any type of controller/processor (e.g. ASIC, RISC, ARM, etc.) that can process user inputs and the stored instructions, and communications module/communications interface 1914 transmits and receives information.

Finally with respect to FIG. 19, the controller housing 1914 can be any suitable housing. In one embodiment, housing 1914 has a form factor such that mobile device 1902 is able to fit within a user's hand. Housing 1914 may however be larger (e.g. tablet sized) and is not limited to any particular form factor.

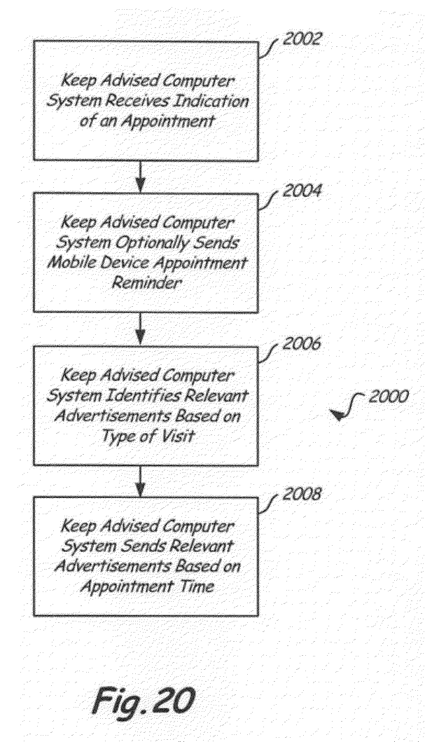

FIG. 20 is a process flow diagram of an event based advertising method 2000. At block 2002, a Keep Advised computer system receives an indication of an appointment. The indication of the appointment may include a day and time of the appointment, and a name of a physician, physician's office, clinic, etc. that the appointment is with. At block 2004, the Keep Advised computer system optionally sends the patient's mobile device an appointment reminder. The reminder can be initiated by the physician, etc. that the patient has the appointment with, or can be initiated by any other manner. At block 2006, the Keep Advised computer system identifies relevant advertisements based on the type of appointment. For instance, if the appointment is with a dentist, the advertisement might be for a teeth whitening product. Or, if the appointment is with a cardiologist, the advertisement might be for a brand of aspirin. Finally, at block 2008, the Keep Advised computer system sends one or more relevant advertisements based on the appointment day and time. For example, an advertisement could be sent shortly before, during, or after an appointment, or at any other appropriate time. Accordingly, method 2000 can illustratively be used to provide specific, individualized, custom advertisements based on appointment information.

Embodiments of the present disclosure illustratively include one or more of the features described above or shown in the figures. Certain embodiments include a system for managing and sharing electronic medical records. In one embodiment, an electronic medical record and/or web portal is connected to an individual's mobile device to provide medical and/or other types of information. For example, real-time updates about a patient's status and location can be sent to a mobile device. Information about a patient's procedure and/or diagnosis can also be sent. Furthermore, in some embodiments, advertising may be sent such as, but not limited to, advertisements specific to an institution's businesses (e.g. cafeteria, gift shop, etc.), advertisements specific to a patient's medical providers (which may be optimized for sharing with other mobile device users and potential future clients), advertisements specific to the current day and/or time, and advertisements that are targeted based on appointment information.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method for communicating health care information to a mobile device, the method comprising:
receiving health care information from a health care provider or a health care institution;
determining whether or not a user is registered to receive health care information on a mobile device; and
transmitting the health care information to the mobile device based at least in part on a determination that the user is registered.

2. The method of claim 1, wherein the health care information is also transmitted based at least in part on an occurrence of a triggering event.

3. The method of claim 2, wherein the triggering event occurs while a patient is receiving health care.

4. The method of claim 2, wherein the triggering event occurs after a patient has received health care.

5. The method of claim 1, wherein the health care information is received from an electronic medical record system.

6. The method of claim 1, wherein the health care information is received from a web portal.

7. The method of claim 1, and further comprising:
transmitting additional information to the mobile device.

8. The method of claim 7, wherein the additional information includes advertisements.

9. A computer-implemented system for receiving health care information on a mobile device, the system comprising:
a user interface displayed on a mobile device, the user interface including a list of health care messages that is updated in real-time.

10. The system of claim 9, wherein each message includes an indication of a health care provider.

11. The system 9, wherein each message includes an indication of a time when the message was received.

12. The system of claim 9, and further comprising:
a menu having a number of selectable buttons.

13. The system of claim 12, wherein the selectable buttons include a button that enables a user to search for a health care provider.

14. The system of claim 12, wherein the selectable buttons include a button that enables a user to search for a health care organization.

15. A computer-implemented system for receiving health care information on a mobile device, the system comprising:
downloading an application to a mobile device; and
updating a display of the mobile device with health care information upon an occurrence of a triggering event.

16. The system of claim 15, wherein the application is downloaded to the mobile device utilizing a link sent to the mobile device in a text message.

17. The system of claim 15, wherein the triggering event is associated with a medical procedure.

18. The system of claim 15, and further comprising:
utilizing the display to provide information about a health care provider.

19. The system of claim 15, and further comprising:
utilizing the display to provide information about a health care facility.

20. The system of claim 15, and further comprising:
utilizing the display to provide information about a health care organization.
